(19) United States
(12) Patent Application Publication
(10) Pub. No.: US 2014/0162765 A1
(43) Pub. Date: Jun. 12, 2014

(54) ONLINE TRADING OF VIRTUAL CHARACTERS

(71) Applicant: Tencent Technology (Shenzhen) Company Limited, Shenzhen (CN)

(72) Inventors: Jie Bai, Shenzhen (CN); Bao Sheng Luo, Shenzhen (CN); Liang Chen, Shenzhen (CN); Yan Xiang Yu, Shenzhen (CN); Jiang Tao Li, Shenzhen (CN); Chong Ru Wang, Shenzhen (CN); Jin Hui Xie, Shenzhen (CN); Zhen Ming Chen, Shenzhen (CN); Li Chun Li, Shenzhen (CN); Wei Hong Mo, Shenzhen (CN); Sha Li, Shenzhen (CN); Xiao Hua Ran, Shenzhen (CN); Jie Chen, Shenzhen (CN); Yao Hua Tan, Shenzhen (CN); Gan Lei, Shenzhen (CN); Tao Hu, Shenzhen (CN); Jin Liu, Shenzhen (CN)

(73) Assignee: Tencent Technology (Shenzhen) Company Limited, Shenzhen (CN)

(21) Appl. No.: 14/103,711

(22) Filed: Dec. 11, 2013

Related U.S. Application Data
(63) Continuation of application No. PCT/CN2013/085940, filed on Oct. 25, 2013.

(30) Foreign Application Priority Data
Dec. 6, 2012 (CN) 201210519566.6

(51) Int. Cl. A63F 13/30

(52) U.S. Cl. CPC A63F 13/12
USPC 463/25

(57) ABSTRACT

Automatic trading of virtual characters in online applications comprises publishing virtual characters by a first user in a trading system that involves verification at an application server and locking of the selected virtual characters at the application server. This can ensure that the trading of virtual characters is true, reliable and prompt, and reduces the loss to users arising from the trading of virtual characters.

### CROSS REFERENCE TO RELATED APPLICATION

This application is a U.S. continuation application under 35 U.S.C. §111(a) claiming priority, under 35 U.S.C. §120 and 365(c), to International Application No. PCT/CN2013/085940 filed on Oct. 25, 2013, which claims the priority benefit of Chinese Patent Application No. 201210519566.6, filed on Dec. 6, 2012, the contents of both the PCT application and the Chinese application are incorporated by reference herein in their entirety for all purposes.

### FIELD OF THE DISCLOSURE

This relates to online trading of virtual characters, including automatic trading of virtual characters in online applications.

### BACKGROUND

With the rapid development of various online applications such as online games, a great amount of game players are involved. Trading virtual characters and virtual currency in the game world has become more and more popular among game players.

However, due to lack of an effective supervision platform, sellers are subject to fewer restrictions when they publish virtual characters during the trading of virtual characters. From time to time, there are situations where malicious sellers engage in fraud by publishing false information. Existing virtual character trading systems cannot determine whether the virtual characters published by sellers are true and effective.

### SUMMARY

Automatic trading of virtual characters for online applications is provided that can solve the problem of truth and effectiveness of virtual character trading and reduce disputes arising from the trading of virtual characters.

For example, a trading system can obtain from an application server information about virtual characters owned by a first user after the first user logs into the trading system, display the information about the virtual characters on a first front-end page in the trading system and obtain a selected virtual character, publish the selected virtual character in the trading system and send a virtual character locking request to the application server to allow the application server to lock the selected virtual character, display the locked virtual character on a second front-end page in the trading system, and send a virtual character transfer request to the application server upon receiving information confirming a completed purchase by a second user to allow the application server to transfer the locked virtual character to an account of the second user. The application server can lock the selected virtual character according to the virtual character locking request from the trading system and transfer the locked virtual character into the account of the second user according to the virtual character transfer request from the trading system.

By publishing virtual characters by a first user in a trading system that involves verification at an application server and locking of the selected virtual characters at the application server, the trading of virtual characters can be true, reliable and prompt, and reduce the loss to users arising from the trading of virtual characters.

### BRIEF DESCRIPTION OF THE DRAWINGS

FIG. 1 illustrates an example of automatic trading of virtual characters in an online application.

FIG. 2 illustrates an example of a flow chart of automatic trading of virtual characters in an online application.

FIG. 3 illustrates an example of timing and sequence of a seller engaging in automatic trading of virtual characters in an online application.

FIG. 4 illustrates an example of timing and sequence of buyer engaging in automatic trading of virtual characters in an online application.

FIG. 5 illustrates an example of a system architecture for automatic trading of virtual characters in an online application.

FIG. 6 illustrates an example of a computing device.

### DETAILED DESCRIPTION

The present disclosure is directed to providing online trading of virtual characters in a true, reliable and prompt manner. Although the embodiments disclosed herein describe online trading of virtual characters, the disclosure is not so limited and can be used to providing online trading of any type of virtual entity.

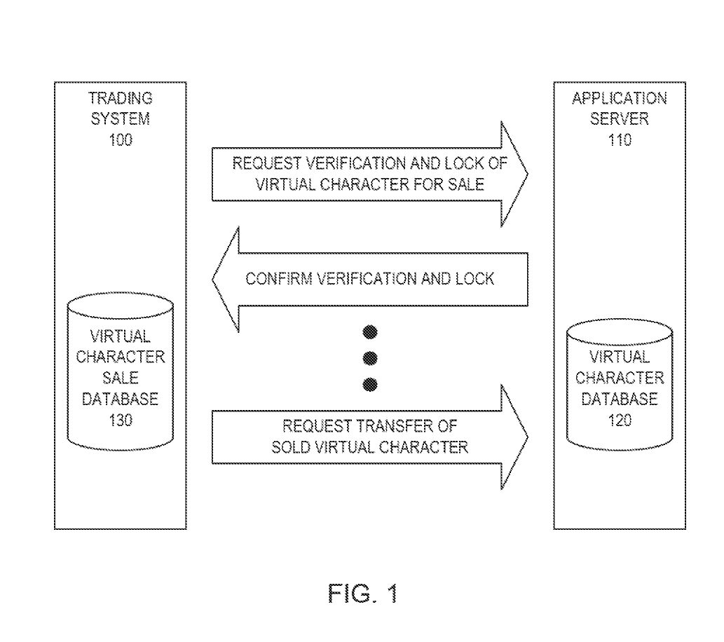

FIG. 1 illustrates an example of automatic trading of virtual characters in an online application. In the illustrated embodiment, trading system 100 communicates with application server 110 to facilitate trading of a virtual character associated with application server 110. Application server 110 can comprise an online application such as an online game, virtual cyberspace, etc. A virtual character can be an online character such as a character created by a user to experience various virtual services in an online application having such characters as a medium. Database 120 can store information on the virtual characters associated with application server 110, such as account and state information, and database 130 can store information on the sale of virtual characters associated with application server 110.

Trading system 100 can allow users to buy or sell virtual characters associated with application server 110. When a user who owns a virtual character wishes to sell the virtual character, trading system 100 can request that application server 110 verify the virtual character to be sold and to lock the virtual character (e.g., to prohibit the user from logging in to the virtual character) while the virtual character is on sale. Once application server 110 confirms the verification and lock, the virtual character can be sold via trading system 100. Once sold, trading system 100 can request that application server 110 transfer the sold virtual character from the seller's account with application server 110 to the buyer's account with application server 110.

Thus, by publishing virtual characters by a seller in a trading system that involves verification at the application server and locking of the selected virtual characters at the application server, the trading of virtual characters can be true, reliable and prompt, and reduce the loss to users arising from the trading of virtual characters.

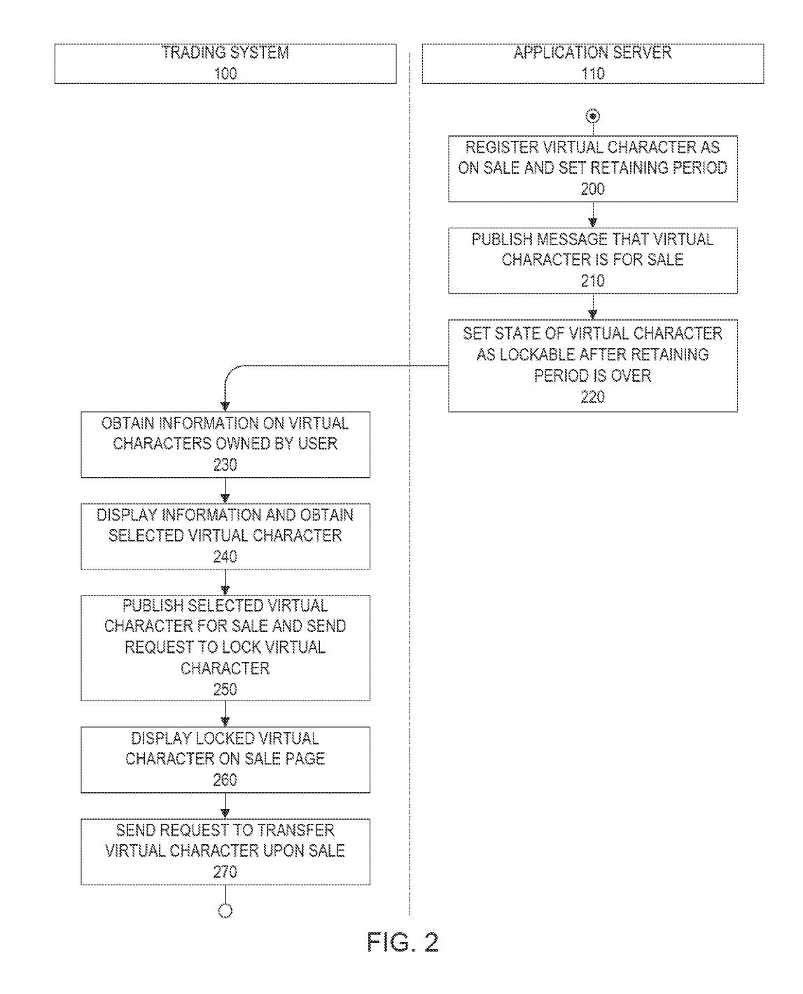

FIG. 2 illustrates an example of a flow chart of automatic trading of virtual characters in an online application. In the illustrated embodiment, blocks 230-270 describe how trading system 100 can verify and lock virtual characters that are on sale at application server 100 so as to ensure true and effective trading, and blocks 200-220 describe how a retaining period (e.g., a period before the first user is permitted to trade a particular virtual character) can be pre-set and published with application server 110 in order to avoid adverse effect on the relevant person after the trading of virtual characters. The process illustrated in blocks 200-220 is optional in the illustrated embodiment.

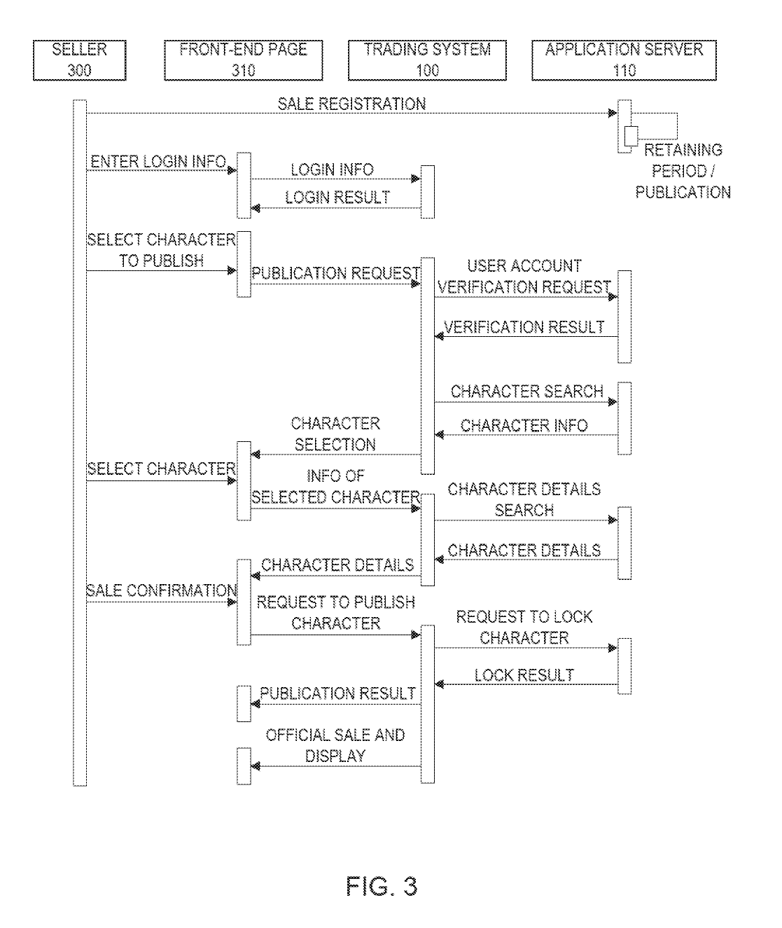

In block 200, the application server can register virtual characters on sale according to a request of a first user (e.g., seller 300) and set a retaining period for the virtual characters on sale. As illustrated in FIG. 3, the first user can log into the application server to register the virtual character as on sale in the application server. For example, the application server can run online games services and the first user can register the selling of a virtual character at a particular Non-Player Character (NPC). The retaining period of the virtual character to be sold can start to count down when the registration finishes. Examples of a retaining period can be any suitable time period such as several days, one day, or a shorter period of time.

In block 210, the application server can publish news that a virtual character is available for sale during the retaining period. For the virtual character that has been registered for sale, the application server can inform game friends or other persons related to or associated with that character through any suitable notification method such as emails, messages, etc.

In block 220, the application server can set the status of the virtual character on sale as lockable after expiration of the retaining period. Upon expiration of the retaining period, it can be desirable to lock the virtual character on sale so as to secure the trading.

Thus, a retaining period can be pre-set and published with the application server in order to avoid adverse effect on the relevant person after the trading of virtual characters.

In block 230, the trading system can obtain from the application server information about virtual characters owned by the first user after the first user logs into the trading system.

For example, the trading system can comprise an electronic trading system for virtual characters. In FIG. 3, the trading system can provide users with a login interface on a front-end page (front-end page 310, such as a web page); users (e.g. first users) may log into the trading system with their IDs, such as account password or key file. After the trading system accepts the login verification, the first user can perform various operations associated with virtual characters on the front-end page, including publishing a virtual character in the trading system.

In particular, the process can include the front-end page being loaded and run by a browser program or other program at a client terminal (e.g., computing device) used by the first user. The first user can select to release a virtual character by clicking a specific button or link, etc., on the front-end page. Accordingly, a form or web address dispatching request (e.g., publishing request) on the front-end page can be transmitted to the trading system.

In order to obtain information about virtual characters owned by a first user, the trading system can first send the user verification information to the application server for verification. The application server can comprise a game server for example; the first user can use online game services provided by the game server through interaction between the game client terminal and game server.

The trading system and the application server can share one account number, such that the same account number can be used to log in both the trading system and the application server. In this way, the trading system can directly send the account number and password of the first user in the trading system to the application server for verification.

However, it is understood that the above is not exclusive. For example, the first user can have different account numbers in the trading system and the application server. The first user may combine in the trading system the account number in the trading system and the account number in the application server. The combination can include generating a combination request according to a pre-set protocol, the combination request including user name and other key data of the account number in the trading system, and sending the combination request to the application server and providing a callback address. The application server can provides a login interface after receiving the combination request, and the combination operation is successfully performed when the login verification is accepted and the combination result is then sent to the callback address. In this way, the first user's account number in the trading system can be associated with the account number in the application server.

Further, the trading system can go without combining account numbers, such that the account number and password in the application server can be entered into the trading system each time any virtual character is on sale. The trading system can then send the account number and the password to the application server for verification.

When the verification is accepted by the application server, a request for information about virtual characters owned by the first user can be sent to the application server. In practice, the application server can make available an Application Programming Interface (API) to provide services for obtaining the information about virtual characters. In other words, before block 230 there can be a step of creating an API. The API can comprise a character list query interface, a character details query interface, a character lock interface, a character unlock interface and a character transfer interface. In addition, it is understood that extension of the above interfaces can be desirable in case of need.

Aligned with the characteristics of online applications, the game server can be divided into several zones for example, with each zone including several servers and each server having multiple characters concurrently. It is possible that the first user has one or multiple characters in various servers, while virtual charters on sale may be owned by different characters. Obtaining the information about virtual characters owned by a first user can involve selection of zone, server and character. It can therefore be advantageous for the application server to make available the API for character list query so as to obtain the character list and allow selection by the first user.

In block 240, the trading system can display on the first front-end page of the trading system the information about virtual characters to obtain the selected virtual character.

For example, after obtaining the list of virtual characters owned by the first user, the first front-end page can be generated. The first user can select the virtual characters to be sold on the first front-end page. The first user's operation result can be sent to the server of the trading system. Accordingly, the trading system can obtain the selected virtual characters.

Further, detailed information about the virtual characters can be displayed on the first front-end page. The detailed information can be such information about a virtual character as its basic information, equipment information, backpacks information, skills information, pet information, etc. In particular, the character's ID can be used as an API parameter for the purpose of querying about the list of virtual characters owned. The API for virtual character details query list can be the details information for virtual characters query.

In block 250, the trading system can publish the selected virtual character and send a virtual character locking request to the application server, thereby allowing the application server to lock the selected virtual character.

The publishing of the selected virtual character in the trading system can save the information of virtual character in the database of virtual characters on sale in the trading system (database 130) and register the status as available for sale.

An example of sending a virtual character locking request to the application server to lock the selected virtual character can comprise invoking an API that can lock virtual characters. The trading system can deploy the API and lock the virtual characters owned by the first user according the IDs (possibly the only ID) of the virtual characters. After receiving the locking request, the application server can set the status of corresponding virtual characters being locked according to IDs of the virtual characters such that the locked virtual characters cannot be accessed in the application server.

In block 260, the trading system can display the locked virtual character on a second front-end page (front-end page 410) in the trading system.

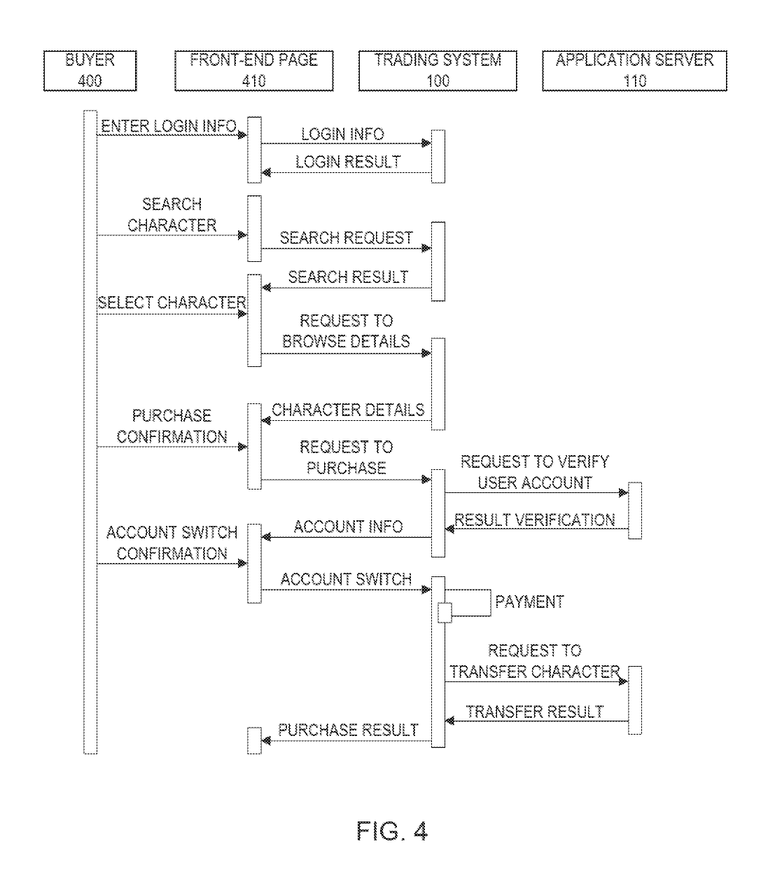

An example of a second front-end page (e.g., a different web page) comprises a page for users to search, browse, and purchase virtual characters. In FIG. 4 for example, after the first user publishes the virtual characters, the trading system can publish on the second front-end page the virtual characters to be sold, so that other users (e.g., a second user) can search, browse, and purchase virtual characters. In the search, users can enter search conditions for the trading system to finish searches and return and display search results. At this time, a second user can select and purchase virtual characters. The purchase can be done as follows.

The second user can select and purchase the particular virtual characters on the second front-end page. Transfer of virtual characters can involve the account into which the virtual characters are to be transferred. The trading system can request for user account verification with the application server. The verification process can be similar to the verification of the first user's account at the application server described in block 230. In the process, the second user can choose the account into which the virtual characters he/she purchased will be transferred. The payment process can then start. It is understood that any suitable form of online payment can be applied to make the payment.

A virtual character normally is the only commodity of its kind. When the second users selects to purchase, he/she can change the status of the virtual character in the database for virtual characters for sale and lock the virtual character so as to prevent the (selected) virtual character from being purchased by other users in the course of payment. In order to maintain normal sales, the locking status can be automatically terminated if payment is not made or at the expiration of a pre-set time such as 10 minutes.

In block 260, the trading system can send a virtual character transfer request to the application server upon receiving information confirming a completed purchase by the second user, thereby allowing the application server to transfer the locked virtual character to an account of the second user.

An example sending a virtual character transfer request to the application server to transfer the virtual characters purchased by the second user comprises invoking an API that can transfer virtual characters. The trading system can deploy the API and transfer the virtual characters into the account of the second user according to the IDs of the virtual characters for example. In the transfer process, the ID of the virtual character can remain unchanged.

Further, it is understood that after transfer of title of any virtual character, e.g., after completion of block 270, it can be possible to update the database for virtual characters on sale to delete the virtual character or mark the status of the virtual character as sold and unlock the virtual character.

Thus, publishing of the virtual characters by the first user in the trading system in the above process involving verification at the application server, and locking of the selected virtual characters at the application server, can ensure the trading of virtual characters to be true, reliable and prompt, and reduce the loss to users arising from the trading of virtual characters.

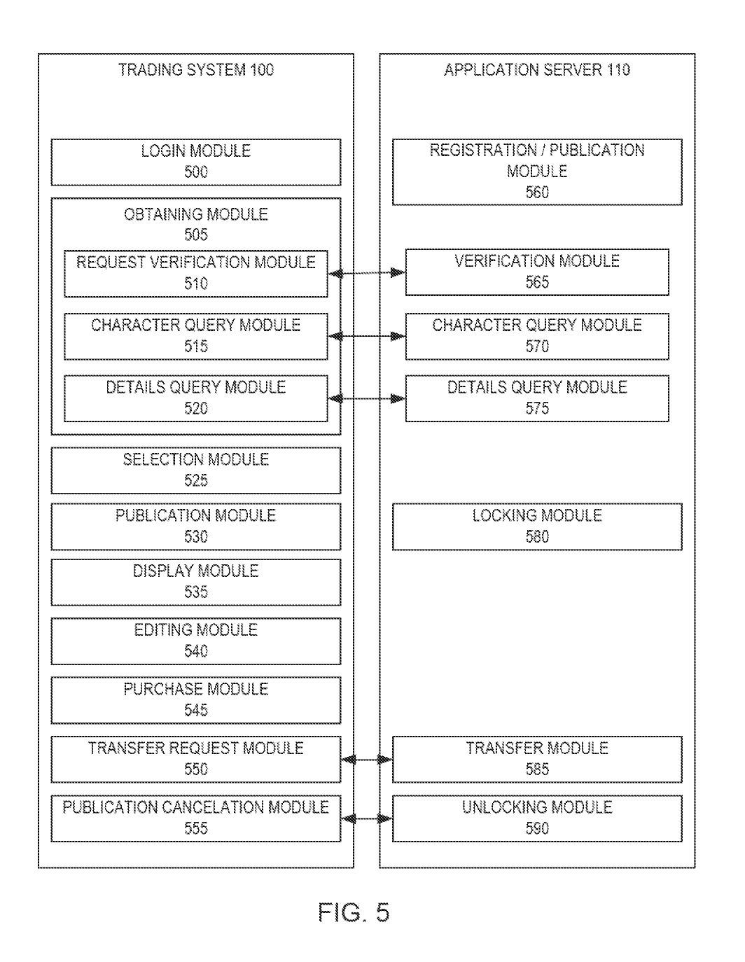

FIG. 5 illustrates an example of a system architecture for automatic trading of virtual characters in an online application. In the illustrated embodiment, trading system 100 can comprise obtaining module 505, selection module 525, publishing module 530, displaying module 535 and transfer request module 550.

Obtaining module 505 can be for obtaining from application server 110 the information about virtual characters owned by a first user after the first user logs into the trading system. Selection module 525 can be for displaying the information about the virtual characters on a first front-end page in the trading system and obtaining a selected virtual character. Publishing module 530 can be for publishing the selected virtual character in the trading system and sending a virtual character locking request to the application server, thereby allowing the application server to lock the selected virtual character. Displaying module 535 can be for displaying the locked virtual character on a second front-end page in the trading system. Transfer request module 550 can be for transferring by the application server the locked virtual character into the game account of the second user after receiving the transfer request sent to the application server when completion of purchase by the second user has been confirmed.

Trading system 100 can also include editing module 540, which can be for changing the status of the virtual characters according to the request of the first user, and publication cancelation module 555, which can be for canceling the transaction according to the request of the first user and sending to the application server the request to unlock said virtual character so as to unlock said virtual character.

Please refer to the above for other details of trading system 100 in automatic trading of virtual characters in online applications.

In trading system 100, publishing of the virtual characters by the first user in the trading system as described above involves verification at the application server, and locking of the selected virtual characters at the application server, which ensures the trading of virtual characters is true, reliable and prompt, and reduces the loss to users arising from the trading of virtual characters.

Optionally trading system 100 can also comprise login module 500 and purchase module 545. Login module 500 can be for receiving the account password from front-end page and performing login verification, and purchase module 545 can be for making payment after selection of purchase of the virtual characters by the buyer (second user) on the second front-end page.

Obtaining module 505 can comprise request verification module 510, character query module 515 as well as details query module 520. Request verification module 510 can be for sending to verification module 565 of application server 110 the user verification request so as to verify whether the user account can be used in application server 110. Character query module 515 can be for inquiring about the information about characters owned by the user in his/her account after the verification is approved by application server 110. Details query module 520 can be for sending to details query module 575 of application server 110 the detailed query request to inquire into detailed information about the virtual characters.

Application server 110 can comprise verification module 565, character query module 570, details query module 475, locking module 580, transfer module 585, and unlocking module 590. It is understood that the various function modules can be modules with functions realized by code and comprise publicly available application programming interfaces, e.g., the proceeding character list query interface, character details query interface, character lock interface, character unlock interface and character transfer interface.

Verification module 565 can be for performing user verification at application server 110 according to the user name, password and other verification information submitted by trading system 100 so as to ensure the user account in trading system 100 is true and accessible.

Character query module 570 can be for inquiring about virtual characters in a user's account according to a character query request from the trading system 100. It is understood that if services run at the application server are not based on characters, character query module 570 may not be necessary.

Details query module 575 can be for inquiring about detailed information about virtual characters according to a detailed query request from trading system 100. Examples of the detailed information can include character basic information, equipment information, backpacks information, skills information, pet information, etc.

Locking module 580 can be for locking virtual characters according to a virtual character locking request of trading system 100. Example of locking can include prohibiting login of the virtual characters.

Transfer module 585 can be for transferring the locked virtual characters into the user's account according to a character transferring request from trading system 100.

Unlocking module 590 can be for unlocking the locked virtual characters according to a character unlocking request from trading system 100.

In addition, application server 110 can also include registration/publication module 560, which can be for registering the virtual character as on sale according to the request of a first user and setting a retaining period for the virtual character on sale before the first user is permitted to log into the trading system, publishing news that the virtual character is available for sale during the retaining period, and setting the status of the virtual character on sale as lockable after expiration of the retaining period.

Thus, publishing of the virtual characters by the first user in the trading system involves verification at the application server, and locking of the selected virtual characters at the application server, which ensures the trading of virtual characters is true, reliable and prompt, and reduces the loss to users arising from the trading of virtual characters.

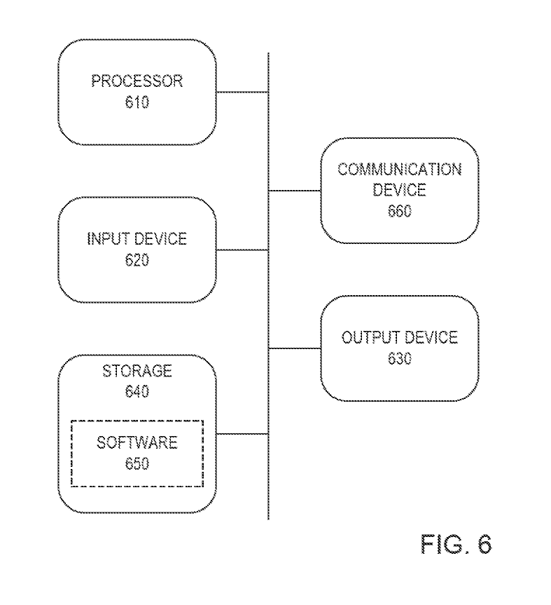

FIG. 6 shows a block diagram of an example of a computing device, which may generally correspond to trading system 100 and application server 110. The form of computing device 600 may be widely varied. For example, computing device 600 can be a personal computer, workstation, server computing device, portable computing device, or any other suitable type of microprocessor-based device. Computing device 600 can include, for example, one or more components including processor 610, input device 620, output device 630, storage 640, and communication device 660. These components may be widely varied, and can be connected to each other in any suitable manner, such as via a physical bus, network line or wirelessly for example.

For example, input device 620 may include a keyboard, mouse, touch screen or monitor, voice-recognition device, or any other suitable device that provides input. Output device 630 may include, for example, a monitor, printer, disk drive, speakers, or any other suitable device that provides output.

Storage 640 may include volatile and/or nonvolatile data storage, such as one or more electrical, magnetic or optical memories such as a RAM, cache, hard drive, CD-ROM drive, tape drive or removable storage disk for example. Communication device 660 may include, for example, a network interface card, modem or any other suitable device capable of transmitting and receiving signals over a network.

The network may include any suitable interconnected communication system, such as a local area network (LAN) or wide area network (WAN) for example. The network may implement any suitable communications protocol and may be secured by any suitable security protocol. The corresponding network links may include, for example, telephone lines, DSL, cable networks, T1 or T3 lines, wireless network connections, or any other suitable arrangement that implements the transmission and reception of network signals.

Software 650 can be stored in storage 640 and executed by processor 610, and may include, for example, programming that embodies the functionality described in the various embodiments of the present disclosure. The programming may take any suitable form. Software 650 may include, for example, the modules of trading system 100 and application server 110 described above.

Software 650 can also be stored and/or transported within any computer-readable storage medium for use by or in connection with an instruction execution system, apparatus, or device, such as computing device 600 for example, that can fetch instructions associated with the software from the instruction execution system, apparatus, or device and execute the instructions. In the context of this document, a computer-readable storage medium can be any medium, such as storage 640 for example, that can contain or store programming for use by or in connection with an instruction execution system, apparatus, or device.

Software 650 can also be propagated within any transport medium for use by or in connection with an instruction execution system, apparatus, or device, such as computing device 600 for example, that can fetch instructions associated with the software from the instruction execution system, apparatus, or device and execute the instructions. In the context of this document, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

It will be appreciated that the above description for clarity has described embodiments of the disclosure with reference to different functional units and processors. However, it will be apparent that any suitable distribution of functionality between different functional units or processors may be used without detracting from the disclosure. For example, functionality illustrated to be performed by separate systems may be performed by the same system, and functionality illustrated to be performed by the same system may be performed by separate systems. Hence, references to specific functional units may be seen as references to suitable means for providing the described functionality rather than indicative of a strict logical or physical structure or organization.

The disclosure may be implemented in any suitable form, including hardware, software, firmware, or any combination of these. The disclosure may optionally be implemented partly as computer software running on one or more processors. The elements and components of an embodiment of the disclosure may be physically, functionally, and logically implemented in any suitable way. Indeed, the functionality may be implemented in a single unit, in multiple units, or as part of other functional units. As such, the disclosure may be implemented in a single unit or may be physically and functionally distributed between different units and processors.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A method comprising:
obtaining from an application server information about virtual characters owned by a first user after the first user logs into a trading system;
displaying the information about the virtual characters on a first front-end page in the trading system and obtaining a selected virtual character;
publishing the selected virtual character in the trading system and sending a virtual character locking request to the application server to allow the application server to lock the selected virtual character;
displaying the locked virtual character on a second front-end page in the trading system; and
sending a virtual character transfer request to the application server upon receiving information confirming a completed purchase by a second user to allow the application server to transfer the locked virtual character to an account of the second user.

2. The method of claim 1 wherein the locking of the selected virtual character by the application server comprises setting a status of the selected virtual character to prohibit logging in of the virtual character.

3. The method of claim 1 comprising
registering by the application server the selected virtual character as on sale according to a request of the first user and setting a retaining period for the virtual character on sale before the first user is permitted to trade in the trading system;
publishing news to sell the virtual character on sale during the retaining period; and
setting a status of the virtual character on sale to be lockable after the retaining period expires.

4. The method of claim 1 comprising changing a transaction status of the selected virtual character in the trading system according to a request of the first user.

5. The method of claim 1 comprising cancelling a transaction according to a request of the first user and sending to the application server a request to unlock the virtual character.

6. The method of claim 1 comprising providing by the application server a character list query interface to allow the trading system to request information identifying the virtual characters owned by the first user, a character details query interface to allow the trading system to request detailed information about one or more virtual characters owned by the first user, a character lock interface to allow the trading system to request that the application server lock the selected virtual character, a character unlock interface to allow the trading system to request that the application server unlock the selected virtual character and a character transfer interface to allow the trading system to request that the application server transfer the locked virtual character to the account of the second user.

7. The method of claim 1 wherein the obtaining from the application server of the information about virtual characters owned by the first user comprises
sending to the application server for verification user authentication information of the first user, and
sending a character query request and obtaining the information about the virtual characters returned by the application server upon approval of the verification by the application server.

8. A trading system comprising one or more processors configured to:
obtain from an application server information about virtual characters owned by a first user after the first user logs into the trading system;
display the information about the virtual characters on a first front-end page in the trading system and obtain a selected virtual character;
publish the selected virtual character in the trading system and send a virtual character locking request to the application server to allow the application server to lock the selected virtual character;
display the locked virtual character on a second front-end page in the trading system; and
send a virtual character transfer request to the application server upon receiving information confirming a completed purchase by a second user to allow the application server to transfer the locked virtual character to an account of the second user.

9. The trading system of claim 8, wherein one or more processors are configured to change a transaction status of the selected virtual character in the trading system according to a request of the first user.

10. The trading system of claim 8, wherein one or more processors are configured to cancel a transaction according to a request of the first user and send to the application server a request to unlock the locked virtual character.

11. The trading system of claim 8, wherein the obtaining from the application server of the information about virtual characters owned by the first user comprises
sending to the application server for verification user authentication information of the first user, and
sending a character query request and obtaining the information about the virtual characters returned by the application server upon approval of the verification by the application server.

12. A system comprising:
a trading system comprising one or more processors configured to
obtain from an application server information about virtual characters owned by a first user after the first user logs into the trading system,
display the information about the virtual characters on a first front-end page in the trading system and obtain a selected virtual character,
publish the selected virtual character in the trading system and send a virtual character locking request to the application server to allow the application server to lock the selected virtual character,
display the locked virtual character on a second front-end page in the trading system, and
send a virtual character transfer request to the application server upon receiving information confirming a completed purchase by a second user to allow the application server to transfer the locked virtual character to an account of the second user; and
an application server comprising one or more processors configured to
lock the selected virtual character according to the virtual character locking request from the trading system, and
transfer the locked virtual character into the account of the second user according to the virtual character transfer request from the trading system.

13. The system of claim 12, wherein the locking of the selected virtual character by the application server comprises setting a status of the selected virtual character to prohibit logging in of the virtual character.

14. The system of claim 12, wherein the application server comprises one or more processors configured to
register the selected virtual character as on sale according to a request of the first user and set a retaining period for the virtual character on sale before the first user is permitted to trade in the trading system;
publish news to sell the virtual character on sale during the retaining period; and
set a status of the virtual character on sale to be lockable after the retaining period expires.

15. The system of claim 12, wherein
the trading system comprises one or more processors configured to
send to the application server for verification user authentication information of the first user, and
send a character query request and obtaining the information about the virtual characters returned by the application server upon approval of the verification by the application server, and
the application server comprises one or more processors configured to
inquire about virtual characters in an account of the first user according to the character query request from the trading system.

16. The system of claim 12, wherein
the trading system comprises one or more processors configured to send a character detail query request to the application server about one or more virtual characters owned by the first user, and
the application server comprises one or more processors configured to inquire about the detailed information about the one or more virtual characters owned by the user according to the character detail query request from the trading system.

17. The system of claim 12, wherein
the trading system comprises one or more processors configured to cancel a transaction according to a request of the first user and send to the application server a virtual character unlocking request to unlock the locked virtual character, and
the application server comprises one or more processors configured to unlock the selected virtual character according to the virtual character unlocking request from the trading system.
